(19) United States
(12) Patent Application Publication
(10) Pub. No.: US 2009/0231986 A1
(43) Pub. Date: Sep. 17, 2009

(54) INFORMATION RECORDING APPARATUS AND METHOD, INFORMATION REPRODUCING APPARATUS AND METHOD, INFORMATION RECORDING MEDIUM, AND COMPUTER PROGRAM

(75) Inventor: Toshiro Tanikawa, Saitama (JP)

Correspondence Address: YOUNG & THOMPSON, 209 Madison Street, Suite 500, ALEXANDRIA, VA, 22314, US

(73) Assignee: PIONEER CORPORATION, Tokyo (JP)

(21) Appl. No.: 11/912,721

(22) PCT Filed: Apr. 24, 2006
(86) PCT No.: PCT/JP2006/308735

§ 371 Date: Oct. 26, 2007

(30) Foreign Application Priority Data
Apr. 27, 2005 (JP) 2005-129043

(51) Int. Cl. G11B 7/24

(52) U.S. Cl. 369/275.3; G9B/7.139

(57) ABSTRACT

An information recording apparatus (200) is provided with: a first recording device (353) for recording record information onto an information recording medium (100) in each border area, which is a unit in which the record information is recorded; and a second recording device (353) for recording a boot program into a first border area of a plurality of border areas which are formed by recording the record information, the boot program being executed by an information reproducing apparatus for reproducing the record information recorded on the information recording medium, the boot program allowing the information reproducing apparatus to recognize each of the plurality of border areas.

### TECHNICAL FIELD

The present invention relates to an information recording medium, such as a DVD, an information recording apparatus and method, such as a DVD recorder, an information reproducing apparatus and method, such as a DVD player, and a computer program which makes a computer function as such a recording apparatus.

### BACKGROUND ART

An information recording medium, such as a CD-ROM (Compact Disc-Read Only Memory), a CD-R (Compact Disc-Recordable), and a DVD-ROM, for example, has been developed. Moreover, in order to increase the recording capacity of the information recording medium, there has been also developed an information recording medium, such as a multi-layer type or dual-layer type optical disc, in which a plurality of recording layers are laminated or pasted on the same substrate.

On the other hand, for example, in a recordable type information recording medium, such as a DVD-R, management data which indicates the structure of recorded data is recorded into a R-Physical format information zone, which is disposed in a lead-in area. On an information reproducing apparatus, which can recognize such a recordable type information recording medium, the structure of the data on the information recording medium can be recognized by reading the management data recorded in the R-Physical format information zone. As a result, the data is reproduced. On the other hand, an information reproducing apparatus, which cannot recognize such a recordable type information recording medium, cannot recognize the R-Physical format information zone, which is a unique structure to the recordable type information recording medium. In this case, the structure of the data on the information recording medium can be recognized by reading the management data which is recorded in a Control data zone, which has a structure common to that of a read-only type information recording medium, such as a DVD-ROM, and which has a structure similar to that of the R-Physical format information zone. As a result, the data can be reproduced. In the Control data zone, the management data which indicates the address of an end area (i.e. the address immediately before a lead-out area) in which the data can be recorded in the information recording medium is recorded in advance by using embossed pits or the like.

Patent document 1: Japanese Patent Application Laid Open NO. 2000-311346
Patent document 2: Japanese Patent Application Laid Open NO. 2001-23237

### DISCLOSURE OF INVENTION

### Subject to be Solved by the Invention

In such an information recording medium, it is possible to record the data by a unit of border area, which is formed by finely dividing a recording area in the information recording medium, in accordance with the size of the data to be recorded. Specifically, if the size of the data to be recorded is smaller than the recording capacity of the information recording medium, the data is recorded into the border area with a size corresponding to the size of the data, and then if the data is newly additionally recorded (or written once), the data is additionally recorded (or written once) into a new border area which follows the previous border area. By this, the recording capacity of the information recording medium can be effectively used. In this case, the management data which indicates the data structure of the border areas, which are formed by dividing the recording area in the information recording medium, is recorded into the R-Physical format information zone.

However, the information reproducing apparatus, which cannot recognize the R-Physical format information zone, cannot read the management data which indicates the data structure of the border areas, which are formed by finely dividing the recording area in the information recording medium. Moreover, in the Control data zone, the management data, which indicates the data structure on the information recording medium before the data is recorded by the unit of border area, is merely recorded in advance. Thus, the information reproducing apparatus, which cannot recognize the R-Physical format information zone, cannot accurately recognize a plurality of border areas, which are formed by finely dividing the recording area in the information recording medium, so that it has such a technical problem that the data cannot be reproduced.

It is therefore an object of the present invention to provide an information recording apparatus and method, an information reproducing apparatus and method, and an information recording medium, which allow a preferable reproduction operation even if the data is recorded by a unit of border area, and a computer program which makes a computer function as such an information recording apparatus and an information reproducing apparatus.

### Means for Solving the Subject

(Information Recording Apparatus)

The above object of the present invention can be achieved by an information recording apparatus provided with: a first recording device for recording record information onto an information recording medium in each border area, which is a unit in which the record information is recorded; and a second recording device for recording a boot program into a first border area of a plurality of border areas which are formed by recording the record information, the boot program being executed by an information reproducing apparatus for reproducing the record information recorded on the information recording medium, the boot program allowing the information reproducing apparatus to recognize each of the plurality of border areas.

According to the information recording apparatus of the present invention, the record information is recorded in each border area by the unit of the border area by the operation of the first recording device. The border area is a recording unit when the record information is recorded. After a group of record information, which may or may not be related to each other, is recorded into one border area, if a new group of record information needs to be additionally recorded, the new group of record information is recorded into another border area. That is, it can be said that the border area is a unit of segmentizing a recording area on the information recording medium. Each border area has a similar structure to that of a lead-in area and a lead-out area (specifically, a border-in area, a border-out area, or the like described later). Then, management data, which indicates the structure of each border area, is recorded into a R-Physical format information zone or the like, which is disposed in the lead-in area on the information recording medium. Since the information recording medium has such construction, the information reproducing apparatus can preferably reproduce the record information recorded in the border area even if a finalize process is not performed (i.e. even if necessary information is not recorded in the lead-in area and the lead-out area) if the information reproducing apparatus can recognize the R-Physical format information zone or the like.

In particular, in the present invention, the boot program, which is executed by the information reproducing apparatus, for example, in an initial operation of the information reproducing apparatus, is further recorded into the first border area of the plurality of border areas by the operation of the second recording device. The “first border area” herein indicates the border area which is firstly formed by the recording operation of the information recording apparatus. Specifically, in case of the information recording medium having a disc shape, it indicates the border area which is formed on the innermost circumferential side, for example. The boot program allows the information reproducing apparatus to recognize each of the plurality of border areas, by being executed by the information reproducing apparatus. Incidentally, the boot program itself may directly operate so as to allow the information reproducing apparatus to recognize the border areas, by being executed by the information reproducing apparatus. Alternatively, the boot program may indirectly operate so as to allow the information reproducing apparatus to recognize the border areas, by executing some program or the like on the information reproducing apparatus due to the execution of the boot program, or by attaching some driver or the like to the information reproducing apparatus due to the execution of the boot program.

By this, even the information reproducing apparatus, which cannot recognize the R-Physical format information zone or the like, can recognize the plurality of border areas on the information recording medium by executing the boot program. As a result, it is possible to preferably reproduce the record information recorded in the plurality of border areas. That is, according to the information recording apparatus of the present invention, the record information can be recorded such that the preferable reproduction operation can be realized even if the data is recorded by the unit of the border area.

In one aspect of the information recording apparatus of the present invention, the boot program judges whether or not the information reproducing apparatus can recognize an information recording medium other than a read-only type information recording medium.

According to this aspect, by executing the boot program on the information reproducing apparatus, the boot program judges whether or not the information reproducing apparatus can recognize an information recording medium (e.g. a recordable type information recording medium, such as a CD-R and a DVD-R) other than the read-only type information recording medium, such as a CD-ROM and a DVD-ROM. In other words, the boot program judges whether or not the information reproducing apparatus can recognize the R-Physical format information zone or the like. By this, it is possible to judge whether or not it is necessary to make the information reproducing apparatus recognize the border areas by the operation of the boot program.

In another aspect of the information recording apparatus of the present invention, the boot program allows the information reproducing apparatus to recognize each of the plurality of border areas if it is judged that the information reproducing apparatus cannot recognize the information recording medium other than the read-only information recording medium.

According to this aspect, if the information reproducing apparatus cannot recognize the information recording medium other than the read-only type information recording medium, it is possible to selectively make the information reproducing apparatus recognize the border areas by the operation of the boot program. On the other hand, if the information reproducing apparatus can recognize the information recording medium other than the read-only type information recording medium, the information reproducing apparatus can recognize the border areas without depending on the operation of the boot program, by reading the management data which indicates the structure of the border area recorded in the R-Physical format information zone or the like. By this, it is only necessary to make the information reproducing apparatus recognize the border areas by the operation of the boot program, in case of necessity. Thus, it is possible to realize the efficient reproduction operation.

In another aspect of the information recording apparatus of the present invention, the second recording device records the boot program in a position which is a predetermined address away (e.g. in a position which is a predetermined first address away) from an edge portion of the first border area.

According to this aspect, a positional relationship between the edge portion (e.g. a start edge portion, an end edge portion, or the like) of the first border area and the recording area in which the boot program is recorded is fixed. Therefore, the information reproducing apparatus can relatively easily access the edge portion of the first border area, by accessing the position which is shifted by the predetermined address from the recording area which is accessed in reading the boot program. As a result, the information reproducing apparatus can recognize the plurality of border areas by referring to position information or the like described later which is recorded into the edge portion.

In another aspect of the information recording apparatus of the present invention, each of the plurality of border areas includes a data area in which the record information is recorded, and a border-in area and a border-out area in each of which management information for managing the record information, which is recorded in the data area, is recorded as the record information, and the second recording device records the boot program in a position which is in the data area in the first border area and which is a predetermined address away (e.g. which is a predetermined second position away) from the border-out area in the first border area.

According to this aspect, the border area is segmentized into the data area in which content data, such as video information and audio information, is actually recorded as the record information, and the border-in area and the border-out area in each of which the management information for managing the record information, which is recorded in the data area, is recorded as the record information. The border-in area and the border-out area are formed to be adjacent to the both edges of the data area, for example. Then, a positional relationship between the border-out area in the first border area and the recording area in which the boot program is recorded is fixed. Therefore, the information reproducing apparatus can relatively easily access the border-out area in the first border area by accessing the position which is shifted by the predetermined address from the recording area which is accessed in reading the boot program. As a result, the information reproducing apparatus can recognize the plurality of border areas by referring to position information or the like described later which is recorded into the border-out area.

In another aspect of the information recording apparatus of the present invention, the first recording device further records position information into each of the plurality of border areas as the record information, the position information indicating a position of a next border area, and the boot program allows the information reproducing apparatus to access a recording area in which the position information is recorded.

According to this aspect, the position information is further recorded into each border area. The position information indicates the position of the border area which is located next to the border area in which such position information is recorded. That is, the position information indicates the structure of the plurality of border areas as a chain structure. Then, if the information reproducing apparatus executes the boot program, the information reproducing apparatus can read the position information recorded in the first border area. After that, the information reproducing apparatus can recognize the border area, which is located next, which is indicated by the position information, and then it can recognize a border area which is located further next to the recognized next border area. As a result, the information reproducing apparatus can preferably recognize the plurality of border areas.

In another aspect of the information recording apparatus of the present invention, each of the plurality of border areas includes a data area in which the record information is recorded, and a border-in area and a border-out area in each of which management information for managing the record information, which is recorded in the data area, is recorded as the record information, the first recording device further records position information into the border-out area in each of the plurality of border areas as the record information, the position information indicating a position of at least one of the border-out area in a border area next to the border area and the border-in area in a border area further next to the next border area, and the boot program allows the information reproducing apparatus to access the border-out area in the first border area.

According to this aspect, the position information is further recorded into the border-out area of each border area. The position information indicates at least one of (i) the position of the border-out area in the border area which is located next to the border area to which the border-out area with such position information recorded belongs and (ii) the position of the border-in area in the border area which is located further next to the border area which is located next to the border area to which the border-out area with the position information recorded belongs. That is, the position information indicates the structure of the plurality of border areas as the chain structure. Then, if the information reproducing apparatus executes the boot program, the information reproducing apparatus can read the position information recorded in the border-out area in the first border area. After that, the information reproducing apparatus can recognize the border area, which is located next, which is indicated by the position information, and then it can recognize the border area which is located further next to the recognized next border area. As a result, the information reproducing apparatus can preferably recognize the plurality of border areas.

In another aspect of the information recording apparatus of the present invention, the information recording medium is provided with a first recording layer and a second recording layer in which the record information is recorded, the first recording device records the record information by the unit of the border area which is over the first recording layer and the second recording layer, and the second recording device records the boot program into at least one of the first recording layer and the second recording layer.

According to this aspect, even in case of a two-layer type (i.e. dual-layer type) or multilayer type information recording medium, the aforementioned various benefits can be received.

In an aspect of the information recording apparatus which records the record information into the first recording layer and the second recording layer of the information recording medium, the first recording device mat record the record information by the unit of the border area including a partial recording area of the first recording layer and a partial recording area of the second recording layer, which faces to the partial recording area of the first recording layer.

According to this aspect, the border area is formed by recording the record information of substantially the same size, alternately into the first recording layer and the second recording layer. Therefore, it is possible to substantially equalize the size of the record information recorded in the first recording layer with the size of the record information recorded in the second recording layer. By this, it is possible to reduce a time required for a finalize process.

The second recording device of the information recording apparatus of the present invention records the boot program onto the information recording medium by using a Boot Descriptor in a UDF (Universal Disk Format) file system.

According to this aspect, it is possible to record the boot program which is executed by the information reproducing apparatus (in particular, executed in an initial operation), relatively easily, by using the format of the UDF file system.

(Information Recording Method)

The above object of the present invention can be also achieved by an information recording method provided with: a first recording process of recording record information onto an information recording medium in each border area, which is a unit in which the record information is recorded; and a second recording process of recording a boot program into a first border area of a plurality of border areas which are formed by recording the record information, the boot program being executed by an information reproducing apparatus for reproducing the record information recorded on the information recording medium, the boot program allowing the information reproducing apparatus to recognize each of the plurality of border areas.

According to the information recording method of the present invention, it is possible to receive the same various benefits as those of the aforementioned information recording apparatus of the present invention.

Incidentally, in response to the various aspects of the aforementioned information recording apparatus of the present invention, the information recording method of the present invention can adopt various aspects.

(Information Reproducing Apparatus)

The above object of the present invention can be also achieved by an information reproducing apparatus for reproducing the record information recorded by the aforementioned information recording apparatus of the present invention (including its various aspects), the information reproducing apparatus provided with: a reading device for reading the boot program; an executing device for executing the read boot program; a recognizing device for recognizing each of the plurality of border areas after the boot program is executed; and a reproducing device for reproducing the record information recorded in each of the plurality of border areas recognized by the recognizing device.

According to the information reproducing apparatus of the present invention, the boot program is read by the operation of the reading device. The read boot program is executed by the operation of the executing device. The executed boot program operates to allow the information reproducing apparatus to recognize each of the plurality of border areas which are formed on the information recording medium. As a result, the recognizing device can recognize each of the plurality of border areas. After that, the record information recorded in each of the recognized plurality of border areas is reproduced by the operation of the reproducing device.

By this, as described above, even the information reproducing apparatus, which cannot recognize the R-Physical format information zone or the like, can recognize the plurality of border areas on the information recording medium by executing the boot program. As a result, it is possible to preferably reproduce the record information recorded in the plurality of border areas. That is, according to the information reproducing apparatus of the present invention, the preferable reproduction operation can be realized even if the data is recorded by the unit of the border area.

In one aspect of the information reproducing apparatus of the present invention, the boot program judges whether or not the information reproducing apparatus can recognize an information recording medium other than a read-only type information recording medium, and the information reproducing apparatus recognizes each of the plurality of border areas if it is judged that the information reproducing apparatus cannot recognize the information recording medium other than the read-only information recording medium.

According to this aspect, by executing the boot program, it is judged whether or not the information reproducing apparatus can recognize the information recording medium other than the read-only type information recording medium. If the information reproducing apparatus cannot recognize the information recording medium other than the read-only type information recording medium, the executed boot program operates so as to allow the information reproducing apparatus to recognize each of the plurality of border areas formed on the information recording medium. As a result, the recognizing device can recognize the border areas, on the basis of the operation of the boot program. On the other hand, if the information reproducing apparatus can recognize the information recording medium other than the read-only type information recording medium, the information reproducing apparatus can recognize the border areas without depending on the operation of the boot program. By this, it is not necessary to make the information reproducing apparatus recognize the border areas unnecessarily. Thus, it is possible to realize the efficient reproduction operation.

In another aspect of the information reproducing apparatus of the present invention, the boot program is recorded in a position which is a predetermined address away from an edge portion of the first border area, and the recognizing device accesses a position which is a predetermined address away from a recording area in which the boot program is recorded, to thereby recognize the first border area.

According to this aspect, a positional relationship between the edge portion of the first border area and the recording area in which the boot program is recorded is fixed. Therefore, the recognizing device can relatively easily access the edge portion of the first border area by accessing the position which is shifted by the predetermined address from the recording area which is accessed when the reading device reads the boot program, on the basis of the operation of the boot program. As a result, the recognizing device can recognize the plurality of border areas by referring to position information or the like described later which is recorded into the edge portion, on the basis of the operation of the boot program.

In another aspect of the information reproducing apparatus of the present invention, each of the plurality of border areas includes a data area in which the record information is recorded, and a border-in area and a border-out area in each of which management information for managing the record information, which is recorded in the data area, is recorded as the record information, the boot program is recorded in a position which is in the data area in the first border area and which is a predetermined address away from the border-out area in the first border area, and the recognizing device accesses a position which is a predetermined address away from a recording area in which the boot program is recorded, to thereby recognize the border-out area in the first border area.

According to this aspect, the border area is segmentized into the data area in which content data, such as video information and audio information, is actually recorded as the record information, and the border-in area and the border-out area in each of which the management information for managing the record information, which is recorded in the data area, is recorded as the record information. Then, a positional relationship between the border-out area in the first border area and the recording area in which the boot program is recorded is fixed. Therefore, the recognizing device can relatively easily access the edge portion of the first border area by accessing the position which is shifted by the predetermined address from the recording area which is accessed when the reading device reads the boot program, on the basis of the operation of the boot program. As a result, the recognizing device can recognize the plurality of border areas by referring to position information or the like described later which is recorded into the border-out area, on the basis of the operation of the boot program.

In another aspect of the information reproducing apparatus of the present invention, position information is recorded in each of the plurality of border areas as the record information, the position information indicating a position of a next border area, and the recognizing device refers to the position information, to thereby recognize each of the plurality of border areas.

According to this aspect, the position information is further recorded into each border area. Therefore, the recognizing device can recognize the border area, which is located next, which is indicated by the position information, with reference to the position information recorded in the first border area, on the basis of the boot program. After that, in the same manner, the recognizing device can recognize a border area which is located further next to the recognized next border area, on the basis of the boot program. As a result, the recognizing device can preferably recognize the plurality of border areas.

In another aspect of the information reproducing apparatus of the present invention, the information recording medium is provided with a first recording layer and a second recording layer in which the record information is recorded, and the record information is recorded by the unit of the border area which is over the first recording layer and the second recording layer.

According to this aspect, even in case of a two-layer type (i.e. dual-layer type) or multilayer type information recording medium, the aforementioned various benefits can be received.

(Information Reproducing Method)

The above object of the present invention can be also achieved by an information reproducing method of reproducing the record information recorded by the aforementioned information recording apparatus of the present invention (including its various aspects), the information reproducing method provided with: a reading process of reading the boot program; an executing process of executing the read boot program; a recognizing process of recognizing each of the plurality of border areas after the boot program is executed; and a reproducing process of reproducing the record information recorded in each of the plurality of border areas recognized by the recognizing process.

According to the information reproducing method of the present invention, it is possible to receive the same various benefits as those of the aforementioned information reproducing apparatus of the present invention.

Incidentally, in response to the various aspects of the aforementioned information reproducing apparatus of the present invention, the information reproducing method of the present invention can adopt various aspects.

(Information Recording Medium)

The above object of the present invention can be also achieved by an information recording medium provided with a plurality of border areas in each of which the record information is recorded, a first border area of the plurality of border areas further provided with a boot area in which a boot program is recorded, the boot program being executed by an information reproducing apparatus for reproducing the record information recorded on the information recording medium, the boot program allowing the information reproducing apparatus to recognize each of the plurality of border areas.

According to the information recording medium of the present invention, by executing the boot program recorded in the boot area, it is possible to make even the information reproducing apparatus, which cannot recognize the information recording medium other than the read-only type information recording medium, recognize the plurality of border areas formed on the information recording medium. Therefore, it is possible to receive the aforementioned various benefits.

Incidentally, in response to the various aspects of the aforementioned information recording apparatus of the present invention, the information recording medium of the present invention can adopt various aspects.

(Computer Program)

The above object of the present invention can be also achieved by a first computer program for recording control to control a computer provided in the aforementioned information recording apparatus of the present invention (including its various aspects), the computer program making the computer function as at least one portion of the first recording device and the second recording device. The above object of the present invention can be also achieved by a second computer program for reproduction control to control a computer provided in the aforementioned information reproducing apparatus of the present invention (including its various aspects), the computer program making the computer function as at least one portion of the reading device, the executing device, the recognizing device, and the reproducing device.

According to each of the computer programs of the present invention, the aforementioned information recording apparatus or information reproducing apparatus of the present invention can be relatively easily realized as a computer reads and executes the computer program from a program storage device, such as a ROM, a CD-ROM, a DVD-ROM, and a hard disk, or as it executes the computer program after downloading the program through a communication device.

Incidentally, in response to the various aspects of the aforementioned information recording apparatus or the aforementioned information reproducing apparatus of the present invention, the first or second computer program of the present invention can adopt various aspects.

The above object of the present invention can be also achieved by a first computer program product in a computer-readable medium for tangibly embodying a program of instructions executable by a computer provided in the aforementioned information recording apparatus of the present invention (including its various aspects), to make the computer function as at least one portion of the first recording device and the second recording device. The above object of the present invention can be also achieved by a second computer program product in a computer-readable medium for tangibly embodying a program of instructions executable by a computer provided in the aforementioned information recording apparatus of the present invention (including its various aspects), to make the computer function as at least one portion of the reading device, the executing device, the recognizing device, and the reproducing device.

According to each of the computer program products of the present invention, the aforementioned information recording apparatus or information reproducing apparatus of the present invention can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as the aforementioned information recording apparatus or information reproducing apparatus of the present invention.

These effects and other advantages of the present invention will become more apparent from the following embodiments.

As explained above, according to the information recording apparatus of the present invention, it is provided with the first recording device and the second recording device. According to the information recording method of the present invention, it is provided with the first recording process and the second recording process. Moreover, according to the information reproducing apparatus of the present invention, it is provided with the reading device, the executing device, the recognizing device, and the reproducing device. According to the information reproducing method of the present invention, it is provided with the reading process, the executing process, the recognizing process, and the reproducing process. Moreover, according to the information recording medium of the present invention, it is provided with the border area and the boot area. Therefore, the preferable reproduction operation can be realized even if the data is recorded by the unit of the border area.

### BRIEF DESCRIPTION OF DRAWINGS

FIG. 1 are explanatory views showing an optical disc in an embodiment of the present invention, with a schematic cross sectional view showing the optical disc having a plurality of areas on the upper side, in association with a conceptual diagram showing an area structure in the radial direction on the lower side.

FIG. 2 is a block diagram conceptually showing the basic structure of an information recording apparatus in an embodiment.

FIG. 3 is an explanatory diagram conceptually showing an aspect of recording the data onto the optical disc by the information recording apparatus in the embodiment.

FIG. 4 is a view explaining the data structures of a border-in area and a border-out area in more details.

FIG. 5 is a block diagram conceptually showing the basic structure of an information reproducing apparatus in an embodiment.

FIG. 6 is a flowchart conceptually showing a flow of a reproduction operation of the information reproducing apparatus in the embodiment.

FIG. 7 is an explanatory diagram conceptually showing one aspect of reproducing the data on the optical disc by the information reproducing apparatus in the embodiment.

FIG. 8 is an explanatory diagram conceptually showing another aspect of reproducing the data on the optical disc by the information reproducing apparatus in the embodiment.

### DESCRIPTION OF REFERENCE CODES

100 Optical disc
102 Lead-in area
102a R-Physical format information zone
102b Control data zone
105 User data area
106 Border-in area
107 Border-out area
109, 119 Middle area
118 Lead-out area
120 Boot program
200 Information recording apparatus
212 Optical pickup
213 Signal recording device
214, 219 CPU
300 Information reproducing apparatus
312 Optical pickup
313 Signal reproducing device
314, 319 CPU

### BEST MODE FOR CARRYING OUT THE INVENTION

Hereinafter, the best mode for carrying out the invention will be explained in each embodiment in order, with reference to the drawings.

(Information Recording Medium)

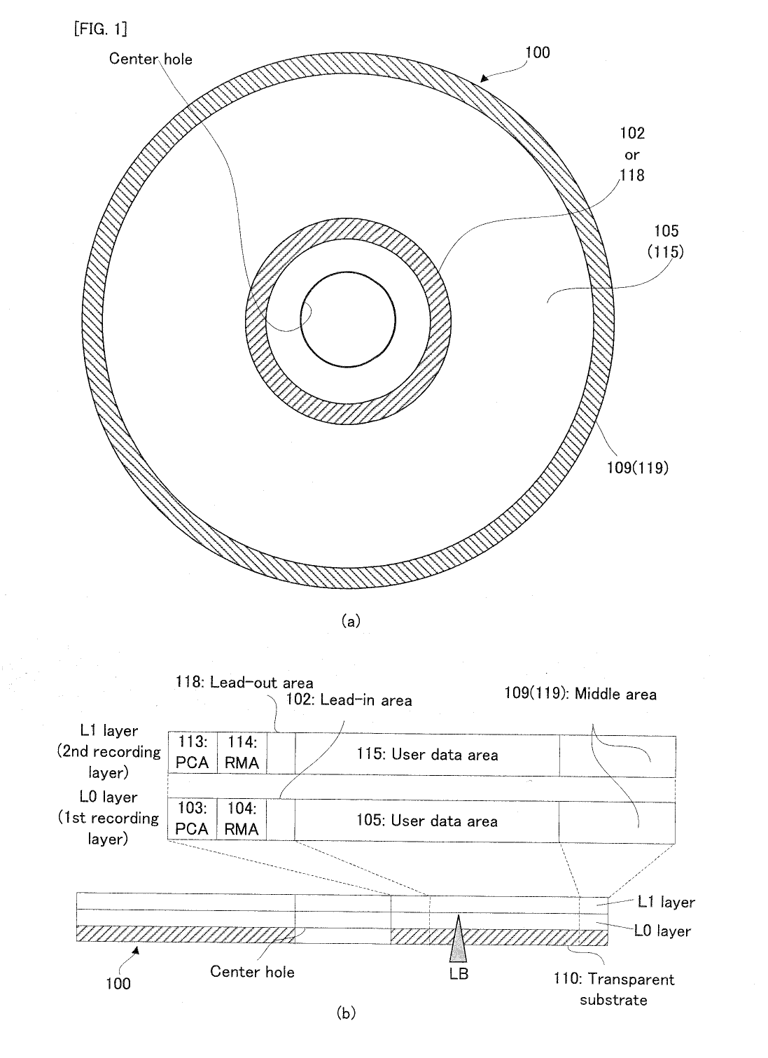

Firstly, with reference to FIG. 1, an explanation will be given on the basic structure of an embodiment of the information recording medium of the present invention. FIG. 1(a) is a substantial plan view showing the basic structure of an optical disc having a plurality of recording areas as the embodiment of the information recording medium of the present invention, and FIG. 1(b) is a schematic cross sectional view of the optical disc and a corresponding conceptual diagram schematically showing a recording area structure in the radial direction.

As shown in FIG. 1(a) and FIG. 1(b), an optical disc 100 has a recording surface on a disc main body with a diameter of about 12 cm, as is a DVD. On the recording surface, the optical disc 100 is provided with: a center hole as being the center; a lead-in area 102 or a lead-out area 118; user data areas 105 and 115; and middle areas 109 and 119. Then, in the optical disc 100, recording layers or the like are laminated on a transparent substrate 110, for example. In each recording area of the recording layers, a track or tracks, such as groove tracks and land tracks, are alternately placed, spirally or concentrically, centered on the center hole 101. Moreover, on the track, data is divided by a unit of ECC block and recorded. The ECC block is a data management unit by a pre-format address in which the record information can be error-corrected.

Incidentally, the present invention is not particularly limited to the optical disc having the three areas, as described above. For example, even if the lead-in area 102, the lead-out area 118 or the middle areas 109 and 119 do not exist, a data structure and the like explained below can be constructed. Moreover, as described later, the lead-in area 102, the lead-out area 118 or the middle areas 109 and 119 may be further segmentized.

In particular, the optical disc 100 in the embodiment, as shown in FIG. 1(b), has such a structure that an L0 layer and an L1 layer, which constitute one example of the “first and second recording layers” of the present invention, respectively, are laminated on the transparent substrate 110. Upon the recording and reproduction of such a dual-layer type optical disc 100, the data recording/reproduction in the L0 layer or the L1 layer is performed, depending on which recording layer has the focus position of laser light LB, irradiated from the lower side to the upper side in FIG. 1(b). In particular, in the L0 layer, the data is recorded from the inner circumferential side to the outer circumferential side, while in the L1 layer, the data is recorded from the outer circumferential side to the inner circumferential side. In other words, the optical disc 100 in the embodiment corresponds to an optical disc of an opposite track path style. However, even an optical disc of a parallel track path style can also receive various benefits described later, by adopting a structure discussed below.

Moreover, the optical disc 100 in the embodiment is further provided with: PCA (Power Calibration Areas) 103 and 113; and RMA (Recording Management Areas) 104 and 114, on the inner circumferential side of the lead-in area 102 and the lead-out area 118.

The PCA 103 and 113 are recording areas to perform an OPC (Optimum Power Control) process of adjusting (or calibrating) the laser power of the laser light LB, in recording the data onto the optical disc 100. An OPC pattern is recorded into the PCA 103 and 113 while the laser power is changed in stages, and the reproduction quality (e.g. asymmetry, etc.) of the recorded OPC pattern is measured, by which an optimum laser power in recording the data is calculated.

The RMA 104 and 114 are recording areas to record therein RMD (Recording Management Data) for managing the recording of the data onto the optical disc 100.

Moreover, the optical disc 100 in the embodiment is not limited to a dual-layer, single-sided type, i.e., a dual layer type, but may be a dual-layer, double-sided type. Furthermore, the optical disc 100 in the embodiment is not limited to the optical disc having the two recording layers, as described above, but may be an optical disc of a multilayer type which has three or more layers.

(Information Recording Apparatus)

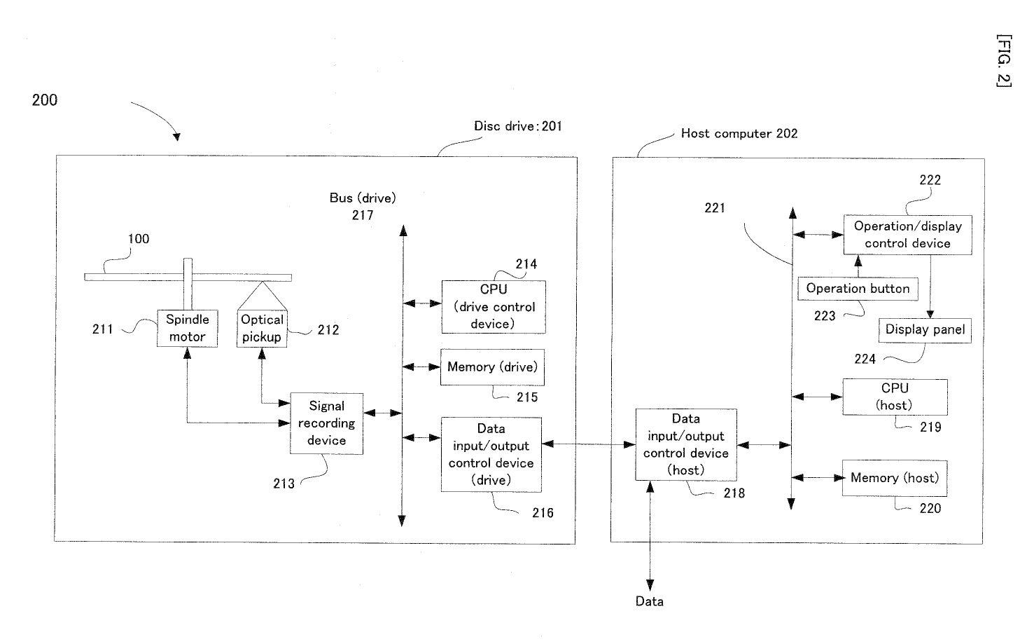

Next, with reference to FIG. 2 to FIG. 4, an explanation will be given on the structure and the operation as an embodiment of the recording apparatus of the present invention.

(1) Basic Structure

Firstly, with reference to FIG. 2, the basic structure of an information recording apparatus 200 will be discussed. FIG. 2 is a block diagram conceptually showing the basic structure of the information recording apparatus 200 in the embodiment. Incidentally, the information recording apparatus 200 has a function of recording the data onto the optical disc 100.

As shown in FIG. 2, the information recording apparatus 200 is provided with: a disc drive 201 into which the optical disc 100 is actually loaded and by which the data is recorded and reproduced; and a host computer 202, such as a personal computer, for controlling the recording and reproduction of the data with respect to the disc drive 201.

The disc drive 201 is provided with: the optical disc 100; a spindle motor 211; an optical pickup 212; a signal recording device 213; a CPU (drive control device) 214; a memory 215; a data input/output control device 216; and a bus 217. Moreover, the host computer 202 is provided with: a data input/output control device 218; a CPU 219; a memory 220; a bus 221; an operation/display control device 222; an operation button 223; and a display panel 224.

The spindle motor 211 is intended to rotate and stop the optical disc 100, and operates upon accessing the optical disc 100. More specifically, the spindle motor 211 is adapted to rotate and stop the optical disc 100 at a predetermined speed, under spindle servo from a not-illustrated servo unit or the like.

The optical pickup 212 is provided with a semiconductor laser device, a lens, and the like, to record the data onto the optical disc 100. More specifically, the optical pickup 212 irradiates the optical disc 100 with a light beam, such as a laser beam, as writing light with a predetermined power upon recording, with it modulated.

The signal recording device 213 controls the spindle motor 211 and the optical pickup 212, to thereby record the data onto the optical disc 100. More specifically, the signal recording device 213 is provided with: a laser diode (LD) driver; a head amplifier; and the like, for example. The laser diode driver (LD driver) drives a not-illustrated semiconductor laser located in the optical pickup 212. The head amplifier amplifies the output signal of the optical pickup 212, i.e. the reflective light of the light beam, and outputs the amplified signal.

The memory 215 is used in the general data processing on the disc drive 201, including a data buffer area, an area used as an intermediate buffer when data is converted into the data that can be used on the signal recording device 213, and the like. Moreover, the memory 215 is provided with: a ROM area into which a program for performing an operation as a recording device, i.e. firmware, is stored; a buffer for temporary storage of the record/reproduction data; a RAM area into which a parameter required for the operation of a firmware program or the like is stored; and the like.

The CPU (drive control device) 214 is connected to the signal recording device 213 and the memory 215 through the bus 217, and controls the entire disc drive 201 by giving an instruction to various controlling devices. Normally, software or firmware for operating the CPU 214 is stored in the memory 215.

The data input/output control device 216 controls the input/output of the data from the exterior with respect to the disc drive 201, to thereby perform storage to and export from the data buffer on the memory 215. A drive control command issued from the external host computer 202, which is connected to the information recording apparatus 200 through an interface, such as a SCSI and an ATAPI, is transmitted to the CPU 214 through the data input/output control device 216. Moreover, the data is also transmitted to and received from the host computer 202 through the data input/output control device 216, in the same manner.

The operation/display control device 222 receives an operation instruction and performs display with respect to the host computer 202, and transmits an instruction by the operation button 223, such as an instruction to record, to the CPU 219. The CPU 219 transmits a control command to the information recording apparatus 200 through the data input/output control device 218, on the basis of instruction information from the operation/display control device 222, to thereby control the entire disc drive 201. In the same manner, the CPU 219 can transmit a command for requesting the disc drive 201 to transmit an operational state to the host, with respect to the disc drive 201. By this, the operational state of the disc drive 201, such as during the recording, can be recognized, so that the CPU 219 can output the operational state of the disc drive 201 on the display panel 224, such as a fluorescent tube and an LCD, through the operation/display control device 222.

The memory 220 is an inner storage apparatus used by the host computer 202, and is provided with: a ROM area into which a firmware program, such as a BIOS (Basic Input/Output System), is stored; a RAM area into which a parameter required for the operation of an operating system and an application program or the like is stored; and the like. Moreover, the memory 220 may be connected to a not-illustrated external storage apparatus, such as a hard disk, through the data input/output control device 218.

One specific example used by combining the disc drive 201 and the host computer 202 explained above is household equipment, such as recorder equipment for recording video images. The recorder equipment records a video signal from a broadcast reception tuner and an external connection terminal, onto a disc. The operation as the recorder equipment is performed by executing a program stored in the memory 220, on the CPU 219. Moreover, in another specific example, the disc drive 201 is a disc drive (hereinafter referred to as a “drive”, as occasion demands), and the host computer 202 is a personal computer and a work station. The host computer, such as the personal computer, and the drive are connected through the data input/output control devices 216 and 218, such as the SCSI and the ATAPI, and application, such as writing software, installed in the host computer 202 controls the disc drive 201.

(2) Operation Principle

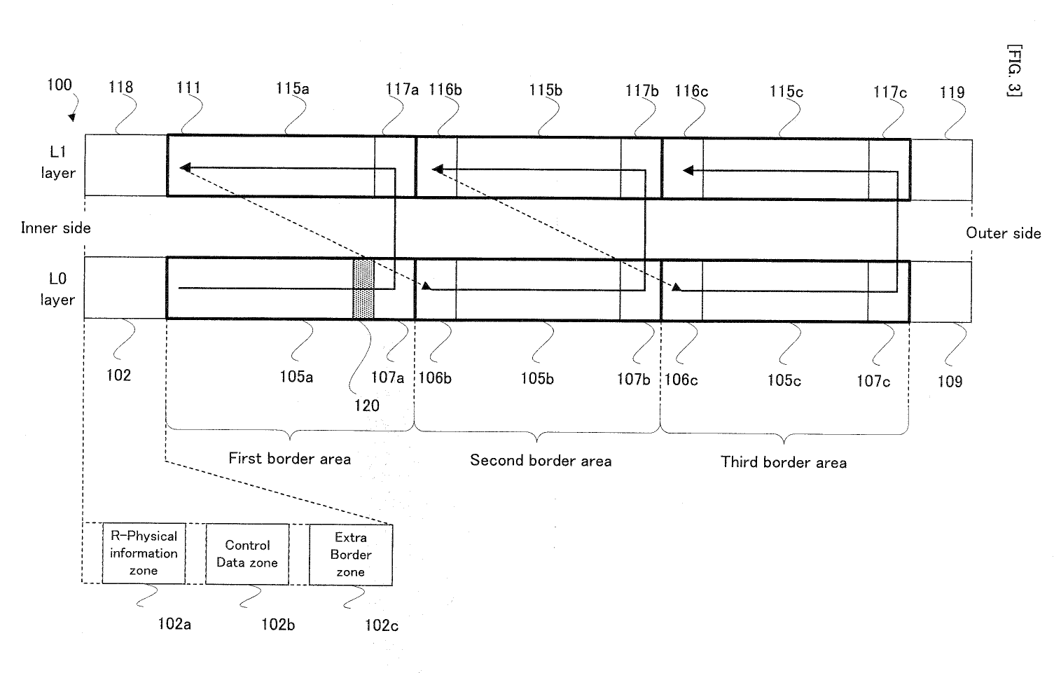

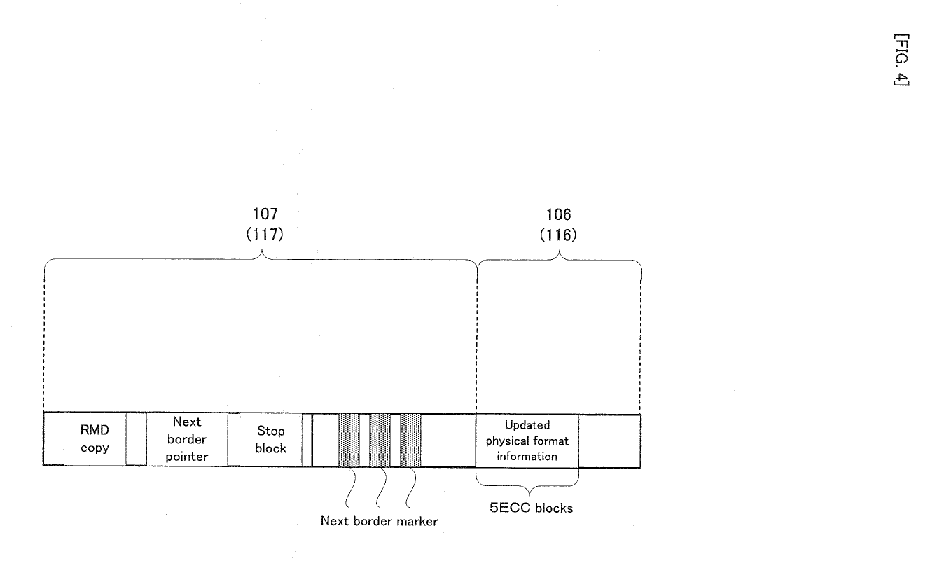

Next, with reference to FIG. 3 and FIG. 4, an explanation will be given on an aspect of recording the data onto the optical disc by the information recording apparatus 200 in the embodiment. FIG. 3 is an explanatory diagram conceptually showing an aspect of recording the data onto the optical disc 100 by the information recording apparatus 200 in the embodiment. FIG. 4 is a view explaining the data structures of a border-in area and a border-out area in more details.

As shown in FIG. 3, the information recording apparatus 200 in the embodiment records various content data, such as movie data and audio data, and other various data or the like by a unit of border area. As a result, a plurality of border areas are formed in the user data areas 105 and 115 in the L0 layer and the L1 layer, respectively. More specifically, firstly, some movie data (or some file) is recorded onto the optical disc 100, by which a first border area is formed. After that, if some music data (or some file) is newly additionally recorded, the music data is recorded following the first border area, by which a second border area is formed. After that, if some data for PC (or some file) is newly additionally recorded, the data for PC is recorded following the second border area, by which a third border area is formed.

The border area will be explained in more details. In each border area, there are formed border-in areas 106 and 116, the user data areas 105 and 115, and border-out areas 107 and 117. However, in the first border area corresponding to the border area which is the first area observed from the lead-in area 102 (i.e. which is formed in the closest position to the lead-in area 102), an extra border zone 102c (or file system information or the like) is recorded into the lead-in area 102, as described later, so that the border-in areas 106 and 116 are not formed. That is, the first border area includes user data areas 105a and 115a and border-out areas 107a and 117a (moreover, the extra border zone 102c or the like). The second border area includes border-in areas 106b and 116b, user data areas 105b and 115b, and border-out areas 107b and 117b. The third border area includes border-in areas 106c and 116c, user data areas 105c and 115c, and border-out areas 107c and 117c.

In the border-in areas 106 and 116, various management information (e.g. updated physical format information or the like) is recorded for managing the data recorded in each border area. Each of the border-in areas 106 and 116 has a size of about several μm in a direction from the inner circumference to the outer circumference of the optical disc 100. The data structures of the border-in areas 106 and 116 will be detailed later (refer to FIG. 4).

In the user data areas 105 and 115, the content data and other various data are actually recorded. In the embodiment, the size of each of the user data areas 105 and 115 may be determined in advance, or it may vary in parallel with the data recording, as occasion demands. Moreover, the user data areas 105 and 115 included in the same border area preferably have such a relationship that they are disposed in the same radial position or in substantially the same radial position, viewed from the optical pickup 211 side. That is, the user data areas 105 and 115 are preferably recording areas which have addresses corresponding to each other.

In the border-out areas 107 and 117, the various management information is recorded for managing the data recorded in each border area. Each of the border-out areas 107 and 117 has a size of about 100 to 500 μm in a direction from the inner circumference to the outer circumference of the optical disc 100. The data structures of the border-out areas 107 and 117 will be detailed later (refer to FIG. 4).

The content data and the various data are recorded in order from the first border area, then into the second border area, and into the third border area. Then, in each border area, as shown with arrows in FIG. 3, the data is recorded from the inner circumferential side of the user data area 105 in the L0 layer, and then, the data is recorded from the outer circumferential side of the user data area 115 in the L1 layer. Moreover, in each border area, a further segmentized data recording section may be defined, and the data may be recorded in each segmentized recording section.

In the middle of the recording operation, the information recording apparatus 200 records the management information into the RMA 104 (or 114), in accordance with the aspect of recording the data on the optical disc 100. More specifically, in the RMA 104 and 114, bitmap information or the like, which indicates an aspect of data distribution on the optical disc 100, is recorded as the RMD. In the middle of the recording operation, the information recording apparatus 200 refers to the RMD recorded in the RMA 104 and 114, to thereby recognize the data distribution (i.e. data structure) on the optical disc 100.

Moreover, the lead-in area 102 is provided, in advance, with: a Recording(R)-Physical format information zone 102a; a Control data zone 102b; an extra border zone 102c.

In the R-Physical format information zone 102a, the newest or updated RMD, which is recorded in the RMA 104 and 114, is recorded in a finalize process. That is, the newest RMD including the bitmap information or the like which indicates the aspect of data distribution on the optical disc 100 at the time of the finalize process is recorded into the R-Physical format information zone 102a in the finalize process. Then, in case of an information reproducing apparatus which can recognize the recordable type optical disc 100, such as a DVD-R (i.e. an information reproducing apparatus which can recognize the R-Physical format information zone 102a), the data distribution on the optical disc 100 is recognized by referring to the R-Physical format information zone 102a, and the data recorded on the optical disc 100 is reproduced.

The Control data zone 102b is a recording area provided even for a read-only type optical disc, and the data structure on the optical disc 100 is recorded therein in advance by using embossed pits, recording pits, recording marks or the like. More specifically, in the Control data zone 102b, the addresses of a start edge portion (i.e. an innermost edge portion) and an end edge portion (i.e. an outermost edge portion) of the lead-in area 102, the address of an end edge portion of a recording area in which the data can be recorded (i.e. the end edge portion of the lead-out area 118), and the like are recorded in advance.

For example, an information reproducing apparatus, which cannot recognize the recordable type optical disc 100 such as a DVD-R, cannot refer to the aforementioned R-Physical format information zone 102a. Thus, the information reproducing apparatus, which cannot recognize the recordable type optical disc 100 such as a DVD-R, refers to the Control data zone 102b, to thereby recognize the data distribution on the optical disc 100. As a result, even the information reproducing apparatus, which cannot recognize the recordable type optical disc 100 such as a DVD-R, can reproduce the data recorded on the optical disc 100.

The extra border zone 102c is a recording area corresponding to the border-in areas 106 and 116 in the first border area.

Next, with reference to FIG. 4, an explanation will be given on the specific data structures of the border-in areas 106 and 116 and the border-out areas 107 and 117. FIG. 4 is a data structure view conceptually showing the specific structures of the border-in areas 106 and 116 and the border-out areas 107 and 117.

As shown in FIG. 4, the updated physical format information is recorded in the border-in areas 106 and 116. The updated physical format information indicates data distribution information (e.g. mapping information or the like) in the user data areas 105 and 115. More specifically, the updated physical format information indicates the data distribution information in the user data areas 105 and 115 when the border-in areas 106 and 116 are formed. Moreover, the updated physical format information has a size corresponding to 5ECC blocks. However, the size is not limited to this.

In the border-out areas 107 and 117, a RMD copy, a stop block, a next border pointer, and a next border marker are recorded.

The RMD copy is information for managing the data recording and includes the same information as that of the RMD recorded in the RMA 104 and 114.

The stop block includes flag information with a size of 2ECC blocks, and it indicates whether or not the data is recorded after the border-out areas 107 and 117. That is, it indicates whether or not the border area is further formed after the border area to which the border-out areas 107 and 117 belong. Therefore, if the information reproducing apparatus, which reproduces the data recorded on the optical disc 100, judges that the data is not recorded by using the stop block, it does not read the subsequent area.

The next border pointer indicates the positions of the border-out areas 107 and 117 in a border area which is located next to the border area to which the border-out areas 107 and 117 belong, and the positions of the border-in areas 106 and 117 in a border area which is located further next to the next border area. Specifically, the next border pointer recorded in the border-out areas 107a and 117a in the first border area indicates the border-out areas 107b and 117b in the second border area and the border-in areas 106c and 116c in the third border area. By virtue of the next border pointer, the plurality of border areas are formed to have a chain structure such that each border area has a series of connection.

The next border marker is information used by the information recording apparatus which records the data onto the optical disc 100, and it is indicated by recording three data, each having a size of 2ECC blocks. Specifically, if the data is further recorded following the border-out areas 107 and 117, predetermined data (e.g. “00h”) is recorded as the next border marker. On the other hand, if the data is not recorded following the border-out areas 107 and 117, border-out areas 107-2 and 117-2 are in a mirror state (i.e. unrecorded state).

In FIG. 3 again, particularly in the embodiment, the information recording apparatus 200 records a boot program 120 immediately before the border-out areas 107 and 117 in the first border area by providing a Boot Descriptor in a UDF file system. Specifically, as shown in FIG. 3, it records the boot program 120 immediately before the border-out areas 107a in the first border area (i.e. into a recording area adjacent to the start edge portion of the border-out area 107a). Incidentally, with regard to the specific explanation on the UDF file system, please refer to UDF Specification (Revision 2.50) issued by OSTA (Optical Storage Technology Association). Of course, even in case of a data structure which complies with another standard, obviously, it is possible to record the boot program 120 explained in the embodiment and perform the operation explained below.

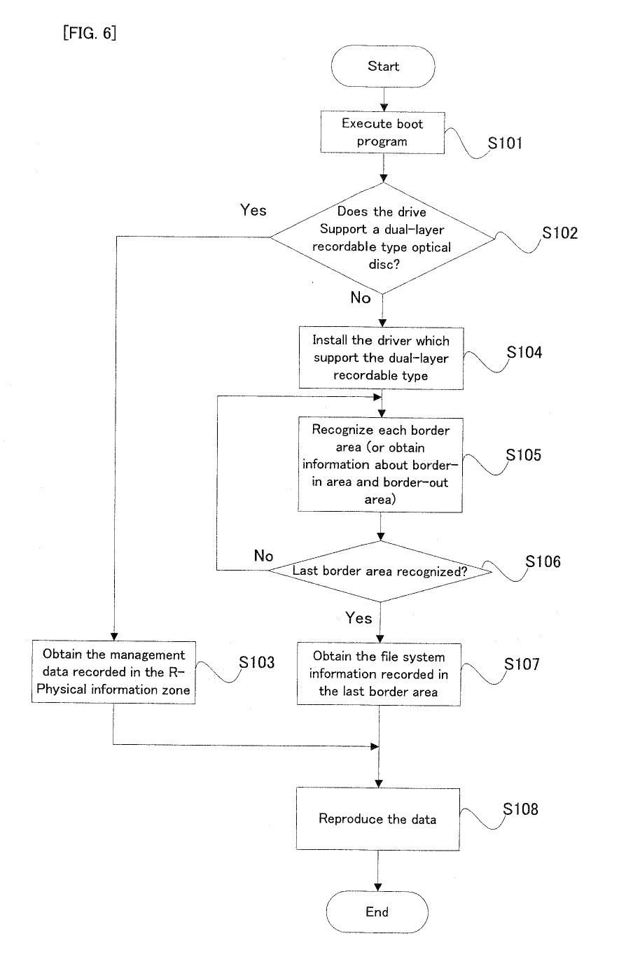

The boot program 120 is a program executed in the initial operation of an information reproducing apparatus described later. If the boot program 120 is executed on the information reproducing apparatus, the boot program 120 judges whether or not the information reproducing apparatus can recognize the optical disc 100 which is of a recordable type and of a dual-layer type. If it is judged that the information reproducing apparatus cannot recognize the optical disc 100 which is of a recordable type and of a dual-layer type, the boot program 120 allows the information reproducing apparatus to recognize the plurality of border areas. Incidentally, a detailed explanation will be given later on the operation when the boot program 120 is actually read and executed by the information reproducing apparatus (refer to FIG. 6 or the like).

(Information Reproducing Apparatus)

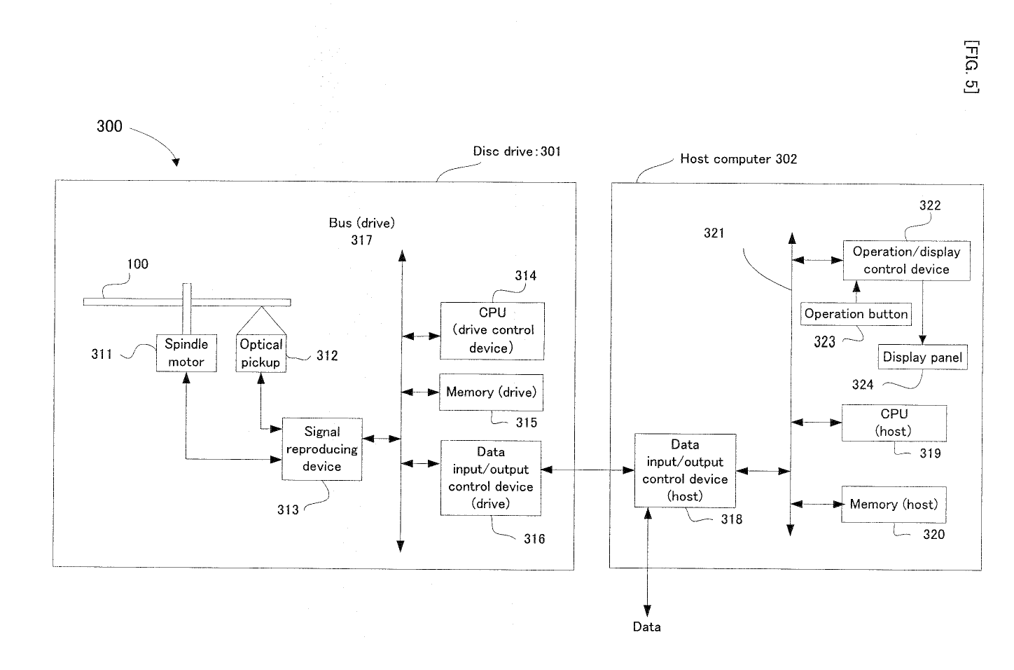

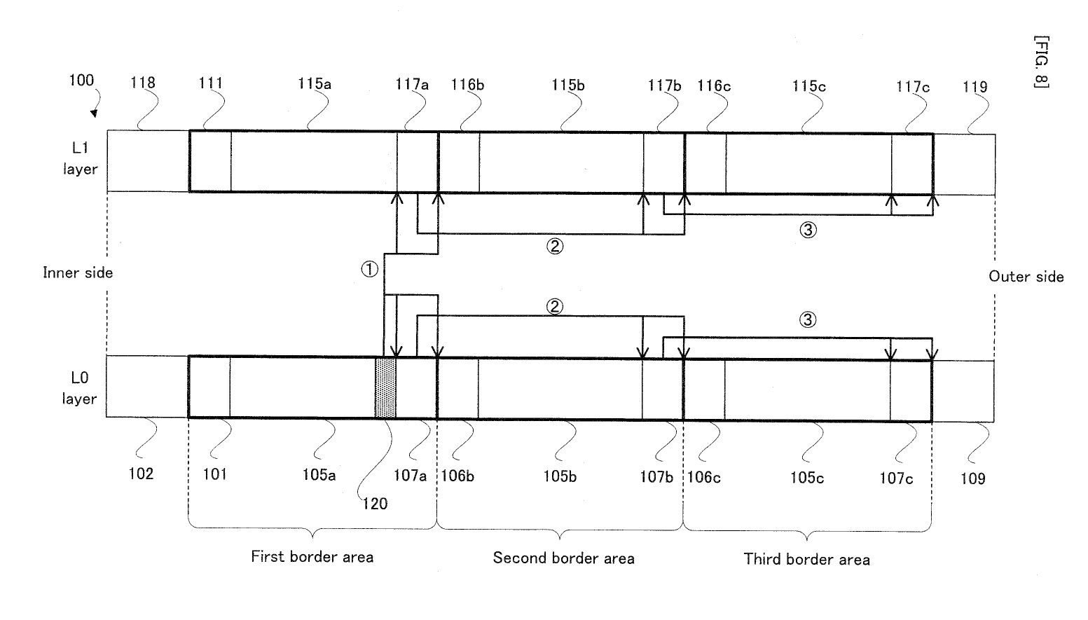

Next, with reference to FIG. 5 and FIG. 8, an embodiment of the information reproducing apparatus of the present invention will be explained.

(1) Basic Structure

Firstly, with reference to FIG. 5, the basic structure of an information reproducing apparatus 300 will be discussed. FIG. 5 is a block diagram conceptually showing the basic structure of the information reproducing apparatus 300 in the embodiment. Incidentally, the information reproducing apparatus 300 has a function of reproducing the data recorded on the optical disc 100 by the information recording apparatus 200.

As shown in FIG. 5, the information reproducing apparatus 300 is provided with: a disc drive 301 into which the optical disc 100 is actually loaded and in which the data is recorded and reproduced; and a host computer 302, such as a personal computer, for controlling the recording and reproduction of the data with respect to the disc drive 301.

The disc drive 301 is provided with: the optical disc 100; a spindle motor 311; an optical pickup 312; a signal reproducing device 313; a CPU (drive control device) 314; a memory 315; a data input/output control device 316; and a bus 317. Moreover, the host computer 302 is provided with: a data input/output control device 318; a CPU 319; a memory 320; a bus 321; an operation/display control device 322; an operation button 323; and a display panel 324.

The spindle motor 311 is intended to rotate and stop the optical disc 100, and operates upon accessing the optical disc 100. More specifically, the spindle motor 311 is adapted to rotate and stop the optical disc 100 at a predetermined speed, under spindle servo from a not-illustrated servo unit or the like.

The optical pickup 312 is provided with a semiconductor laser device, a lens, and the like, to record the data onto the optical disc 100. More specifically, the optical pickup 312 irradiates the optical disc 100 with a light beam, such as a laser beam, as reading light with a predetermined power upon reproduction.

The signal reproducing device 313 controls the spindle motor 311 and the optical pickup 312, to thereby reproduce the data from the optical disc 100. More specifically, the signal reproducing device 313 is provided with: a laser diode (LD) driver; a head amplifier; and the like, for example. The laser diode driver (LD driver) drives a not-illustrated semiconductor laser located in the optical pickup 312. The head amplifier amplifies the output signal of the optical pickup 312, i.e. the reflective light of the light beam, and outputs the amplified signal.

The memory 315 is used in the general data processing on the disc drive 301, including a data buffer area, an area used as an intermediate buffer when data is converted into the data that can be used on the signal reproducing device 313, and the like. Moreover, the memory 315 is provided with: a ROM area into which a program for performing an operation as a recording device, i.e. firmware, is stored; a buffer for temporary storage of the record/reproduction data; a RAM area into which a parameter required for the operation of a firmware program or the like is stored; and the like.

The CPU (drive control device) 314 is connected to the signal reproducing device 313 and the memory 315 through the bus 317, and controls the entire disc drive 301 by giving an instruction to various controlling devices. Normally, software or firmware for operating the CPU 314 is stored in the memory 315.

The data input/output control device 316 controls the input/output of the data from the exterior with respect to the disc drive 301, to thereby perform storage to and export from the data buffer on the memory 315. A drive control command issued from the external host computer 302, which is connected to the information reproducing apparatus 300 through an interface, such as a SCSI and an ATAPI, is transmitted to the CPU 314 through the data input/output control device 316. Moreover, the data is also transmitted to and received from the host computer 302 through the data input/output control device 316, in the same manner.

The operation/display control device 322 receives an operation instruction and performs display with respect to the host computer 302, and transmits an instruction by the operation button 323, such as an instruction to record, to the CPU 319. The CPU 319 transmits a control command to the information reproducing apparatus 300 through the data input/output control device 318, on the basis of instruction information from the operation/display control device 322, to thereby control the entire disc drive 301. In the same manner, the CPU 319 can transmit a command for requesting the disc drive 301 to transmit an operational state to the host, with respect to the disc drive 301. By this, the operational state of the disc drive 301, such as during the recording, can be recognized, so that the CPU 319 can output the operational state of the disc drive 301 on the display panel 324, such as a fluorescent tube and an LCD, through the operation/display control device 322.

The memory 320 is an inner storage apparatus used by the host computer 302, and is provided with: a ROM area into which a firmware program, such as a BIOS (Basic Input/Output System), is stored; a RAM area into which a parameter required for the operation of an operating system and an application program or the like is stored; and the like. Moreover, the memory 320 may be connected to a not-illustrated external storage apparatus, such as a hard disk, through the data input/output control device 318.

One specific example used by combining the disc drive 301 and the host computer 302 explained above is household equipment, such as player equipment for recording video images. The player equipment reproduces a video signal recorded on the optical disc 100. The operation as the player equipment is performed by executing a program stored in the memory 320, on the CPU 319. Moreover, in another specific example, the disc drive 301 is a disc drive (hereinafter referred to as a “drive”, as occasion demands), and the host computer 302 is a personal computer and a work station. The host computer, such as the personal computer, and the drive are connected through the data input/output control devices 316 and 318, such as the SCSI and the ATAPI, and application, such as writing software, installed in the host computer 302 controls the disc drive 301.

(2) Operation Principle

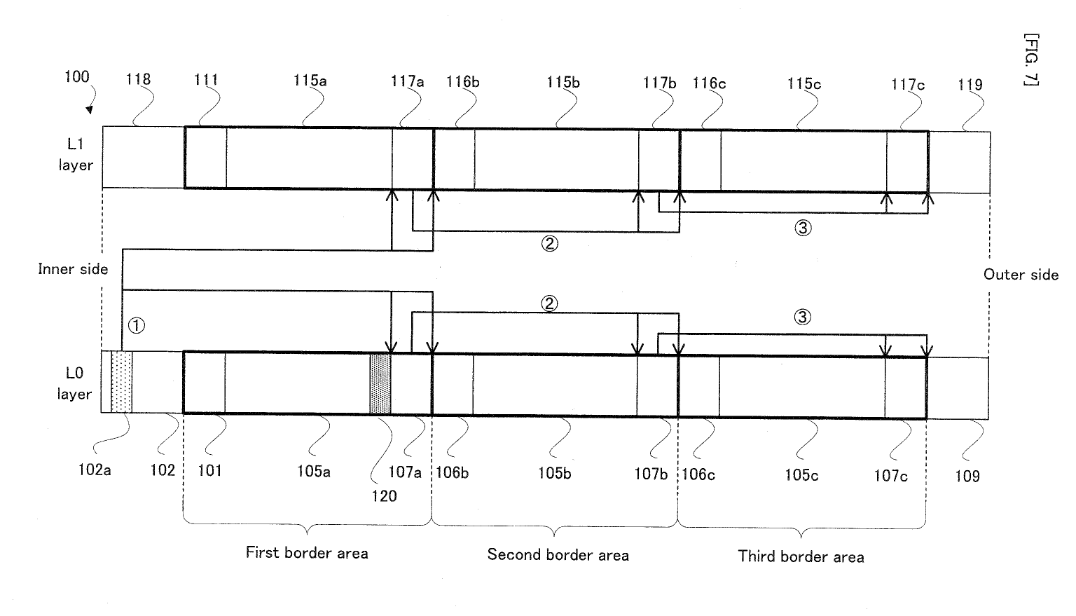

Next, with reference to FIG. 6 to FIG. 8, an explanation will be given on an aspect of reproducing the data recorded on the optical disc 100 by the information reproducing apparatus 300 in the embodiment. FIG. 6 is a flowchart conceptually showing a flow of a reproduction operation of the information reproducing apparatus 300 in the embodiment. FIG. 7 is an explanatory diagram conceptually showing one aspect of reproducing the data on the optical disc 100 by the information reproducing apparatus 300 in the embodiment. FIG. 8 is an explanatory diagram conceptually showing another aspect of reproducing the data on the optical disc 100 by the information reproducing apparatus 300 in the embodiment.

As shown in FIG. 6, firstly, the boot program 120 is read and executed (step S101). The boot program 120 is recorded onto the optical disc 100 by providing the Boot Descriptor in the UDF file system. Thus, if the optical disc 100 is loaded into the information reproducing apparatus 300, the reading and the execution of the boot program 120 are automatically performed as one of the initial operation.

Then, by the operation of the executed boot program 120, it is judged whether or not the information reproducing apparatus 300 can recognize the optical disc 100 which is of a recordable type and of a dual-layer type (step S102). Here, the aforementioned judgment can be performed, relatively easily, by obtaining a Feature code of ATAPI (At Attachment Packet Interface), which is a Mt. Fuji command set.

As a result of the judgment in the step S102, if it is judged that the information reproducing apparatus 300 can recognize the optical disc 100 which is of a recordable type and of a dual-layer type (the step S102: YES), the RMD recorded in the R-Physical format information zone 102a is read (step S103). By this, the information reproducing apparatus 300 recognizes the aspect of the data distribution on the optical disc 100 (more specifically, an aspect of the distribution of the plurality of border areas). As a result, the data recorded in the plurality of border areas can be preferably reproduced (step S108).

FIG. 7 shows a specific aspect of the physical reading (or access) on the optical disc 100 in this reproduction. As shown in FIG. 7, the information reproducing apparatus 300 refers to the RMD recorded in the R-Physical format information zone 102a, to thereby recognize the address of the start edge portion of the border-out areas 107a and 117a in the first border area and the address of the start edge portion of the border-in areas 106b and 116b in the second border area. By this, the information reproducing apparatus 300 can read various information recorded in each of the border-out areas 107a and 117a in the first border area and the border-in areas 106b and 116b in the second border area. If the various information recorded in the border-out areas 107a and 117a is read, it is possible to recognize the address of the start edge portion of the border-out areas 107b and 117b in the second border area and the address of the start edge portion of the border-in areas 106c and 116c in the third border area, by referring to the next border pointer. Moreover, if the various information recorded in the border-in areas 106b and 116b is read, it is possible to recognize the data distribution of the user data areas 105b and 115b in the second border area, by referring to the updated physical format information. By repeating this operation in accordance with the number of the border areas formed on the optical disc 100, the information reproducing apparatus 300 can recognize the plurality of border areas.

An explanation will be given on the logical operation of the information reproducing apparatus 300 according to the UDF file system at this time. The information reproducing apparatus 300 firstly reads the recording area with a LSN (Logical Sector Number) of “16”, to thereby obtain a data structure which is referred to as VRS (Volume Recognition Sequence). After that, it reads the recording area indicated by the LSN obtained by adding “256” to the LSN of the head portion of the last border area (more specifically, the border area formed on the outermost circumferential side) from among the plurality of border areas, which are recognized by reading the RMD recorded in the R-Physical format information zone 102a. By this, the information reproducing apparatus 300 obtains AVDP (Anchor Volume Description Pointer), which is pointer information that indicates an address position (or logical address) in which VDS (Volume Description Sequence) is actually recorded, wherein various information for indicating an entire disc volume space of the optical disc 100 is recorded in the VDS. In the VDS, there are recorded, for example, PVD (Primary Volume Descriptor), LVD (Logical Volume Descriptor), PD (Partition Descriptor), IUVD (Implementation Use Volume Descriptor), USD (Unallocated Space Descriptor), TD (Terminating Descriptor), or the like, as the various information.

At this time, particularly, the LVD indicates an address position in which FSD (File Set Descriptor) is actually recorded. One FSD is provided in each logical disc volume space of the optical disc 100, and it indicates an address position in which a root directory ICB is actually recorded, wherein the root directory ICB is to indicate an actual file structure on the optical disc 100 (specifically, a root directory ICB for indicating a root directory).

In the root directory, a file ID (or file identifier) for identifying each actual file is recorded. For example, the root directory is provided with a file ID about a sub directory (or sub D) and a file ID about a file. Moreover, the file ID about the sub directory indicates an address position in which a sub directory ICB is actually recorded. The file ID about the file indicates an address position in which a file entry ICB is actually recorded. The sub directory ICB indicates an address position in which the entity of the sub directory is actually recorded. Moreover, the file entry ICB indicates an address position in which the entity of the file is actually recorded.

As described above, by recognizing the physical and logical data structure on the optical disc 100, the information reproducing apparatus 300 can recognize each of the plurality of border areas. As a result, it can reproduce the data recorded on the optical disc 100.

On the other hand, if it is judged that the information reproducing apparatus 300 cannot recognize the optical disc 100 which is of a recordable type and of a dual-layer type (the step S102: No), the boot program 120 attaches a driver, which is necessary for the information reproducing apparatus 300 to recognize the plurality of border areas, to the information reproducing apparatus 300 (step S104). By using the driver, the information reproducing apparatus 300 recognizes the plurality of border areas formed on the optical disc 100 (step S105). In other words, the information reproducing apparatus 300 obtains the various information recorded in the border-in areas 106 and 116 and the border-out areas 107 and 117 in each of the plurality of border areas, to thereby recognize the plurality of border areas.

This will be explained more specifically. If it is judged that the information reproducing apparatus 300 cannot recognize the optical disc 100 which is of a recordable type and of a dual-layer type, the information reproducing apparatus 300 cannot recognize the plurality of border areas in the aforementioned method because it cannot recognize the R-Physical format information zone 102a. However, since it can recognize the Control data zone 102b, the information reproducing apparatus 300 can recognize the first border area on a logical volume space of the optical disc 100 (which is so-called the first border area formed between the lead-in area 102 and the lead-out area 118 on the logical volume space). Moreover, the second border area, the third border area, and the like are formed within the first border area on the logical volume space. Thus, the boot program 120 attaches, to the information reproducing apparatus 300, such a driver that allows the information reproducing apparatus 300 to recognize the plurality of border areas by making the information reproducing apparatus 300 read the border-out areas 107 and 117 of the first border area and trace the next border pointer or the like recorded in the border-out areas 107 and 117. Moreover, the boot program 120 attaches, to the information reproducing apparatus 300, such a driver that allows the information reproducing apparatus 300 to recognize the aspect of the data distribution of all the user data areas 105 and 115 (i.e. the user data areas 105 and 115 in each border area) by making the information reproducing apparatus 300 read the updated physical format information recorded in the border-in areas 106 and 116.

FIG. 8 shows a specific aspect of reading (or access) on the optical disc 100 in the reproduction. As shown in FIG. 8, the information reproducing apparatus 300 with the necessary driver attached is controlled to access the border-out area 107a adjacent to the boot program 120, the border-out area 117a, and the border-in areas 106 and 116 in the second border area which is located next to the first border area. If the information reproducing apparatus can access the border-out areas 107a and 117a, it is possible to recognize the border-out areas 107b and 117b in the second border area and the border-in areas 106c and 116c in the third border area, by referring to the next border pointer recorded in the border-out areas 107a and 117a. Moreover, if the information reproducing apparatus 300 can access each of the border-in areas 106b and 116b, it is possible to recognize the aspect of the data distribution (i.e. data structure) in the second border area, by referring to the updated physical format information recorded in the border-in areas 106b and 116b. As a result, the information reproducing apparatus 300 can recognize the second border area. If it can recognize the second border area, the information reproducing apparatus 300 controlled by the driver can recognize the third border area, which is located next to the second border area, by referring the next border pointer recorded in the border-out areas 107b and 117b in the second border area.

After that, the information reproducing apparatus 300 controlled by the driver judges whether or not the last border area is recognized (step S106). For example, if three border areas are formed on the optical disc 100, as shown in FIG. 8, it judges whether or not the third border area is recognized.

As a result of the judgment in the step S106, if it is judged that the last border area is not recognized (the step S106: No), the operational flow returns to the step S105, and the recognition of the border area is continued.

On the other hand, if it is judged that the last border area is recognized (the step S106: Yes), the file system information recorded in the last border area is obtained (step S107). More specifically, as described above, the recording area, which is indicated by the LSN obtained by adding “256” to the LSN of the head portion of the last border area (more specifically, the border area formed on the outermost circumferential side) from among the plurality of border areas, is read. As a result, the information reproducing apparatus 300 can obtain the AVDP, VDS, and the like, as one specific example of the file system information. As a result, it can recognize the logical data structure on the optical disc 100.

As described above, even the information reproducing apparatus 300, which cannot recognize the optical disc 100 which is of a recordable type and of a dual-layer type, can recognize the physical and logical data structure on the optical disc 100 by reading and executing the boot program 120. By this, the information reproducing apparatus 300 can recognize each of the plurality of border areas, and as a result, it can reproduce the data recorded on the optical disc 100.

As explained above, according to the information recording apparatus 200 in the embodiment, the boot program 120 which allows the information reproducing apparatus 300 to perform the aforementioned operation is recorded into the first border area of the plurality of border areas. By this, even the information reproducing apparatus, which cannot recognize the optical disc 100 which is of a recordable type and of a dual-layer type (i.e. the information reproducing apparatus which cannot recognize the R-Physical format information zone 102a), can recognize the plurality of border areas on the optical disc 100, as in the information reproducing apparatus which can recognize the optical disc 100 which is of a recordable type and of a dual-layer type (i.e. the information reproducing apparatus which can recognize the R-Physical format information zone 102a). As a result, it is possible to preferably reproduce the data recorded on the optical disc 100.

In particular, when the optical disc 100 which is of a recordable type and of a dual-layer type starts to be distributed to the market, the information reproducing apparatus does not necessarily support such an optical disc 100. Even in that case, any type of information reproducing apparatus can preferably reproduce the data recorded on the optical disc 100 by employing such construction that the boot program 120 is recorded onto the optical disc 120 and it is executed in the reproduction, as described above. In this regard, it can be said that the present invention has a great advantage.

Moreover, since the boot program 120 is recorded immediately before the border-out area 107a, the information reproducing apparatus 300 can access the border-out area 107a by shifting from the head position (i.e. the start edge portion) of the boot program 120 to the outer circumferential side only by the size of the booty program 120 itself. Therefore, even if the information reproducing apparatus 300 cannot recognize the structures of the plurality of border areas, it is possible to make the information reproducing apparatus 300 access the border-out area 107a, relatively easily. As a result, it is possible to make the information reproducing apparatus 300 recognize the plurality of border areas, by making the apparatus refer to the next border pointer recorded in the border-out area 107a.

Incidentally, in the aforementioned embodiments, the boot program 120 is recorded immediately before the border-out area 107a; however, it is obvious that the present invention is not limited to this. That is, if the boot program 120 and the border-out area 107a have a predetermined positional relationship determined in advance, it is possible to make the apparatus access the border-out area 107a from the recording area in which the boot program 120 is recorded, relatively easily. As a result, it is possible to receive the aforementioned various benefits.

Moreover, in the aforementioned embodiments, the explanation is given by using the dual-layer type optical disc 100 as a specific example of the information recording medium. However, it is obvious that the aforementioned various benefits can be received by employing the aforementioned construction or configuration, even for a dual-layer type optical disc and a multilayer type optical disc having three or more recording layers.

Moreover, in the aforementioned embodiments, the optical disc 100 is explained as one example of the information recording medium, and the recorder or player related to the optical disc 100 is explained as one example of the information recording/reproducing apparatus. The present invention, however, is not limited to the optical disc and the recorder thereof, and can be applied to other various recording media, and the recorders or players thereof, which support high density recording or high transfer rate.

The present invention is not limited to the above-described embodiments, and various changes may be made, if desired, without departing from the essence or spirit of the invention which can be read from the claims and the entire specification. An information recording apparatus and method, an information reproducing apparatus and method, and a computer program for recording control or reproduction control, which involve such changes, are also intended to be within the technical scope of the present invention.

### INDUSTRIAL APPLICABILITY

The information recording apparatus and method, the information reproducing apparatus and method, the information recording medium, and the computer program according to the present invention can be applied to a recording medium, such as a CD and a DVD, and also applied to an information recording/reproducing apparatus, such as a DVD recorder and a DVD player. Moreover, they can be applied to an information recording/reproducing apparatus or the like, which is mounted on or can be connected to various computer equipment for consumer use or business use, for example.

1-21. (canceled)

22. An information recording apparatus comprising:
a first recording device for recording record information onto an information recording medium in each border area, which is a unit in which the record information is recorded; and
a second recording device for recording a boot program into a first border area of a plurality of border areas which are formed by recording the record information, the boot program being executed by an information reproducing apparatus for reproducing the record information recorded on the information recording medium, the boot program allowing the information reproducing apparatus to recognize each of the plurality of border areas, wherein
each of the plurality of border areas includes a data area in which the record information is recorded, and a border-in area and a border-out area in each of which management information for managing the record information, which is recorded in the data area, is recorded as the record information,
said second recording device records the boot program in a position which is in the data area in the first border area and which is a predetermined address away from the border-out area in the first border area,
said first recording device further records position information into the border-out area in each of the plurality of border areas as the record information, the position information indicating a position of at least one of the border-out area in a border area next to the border area and the border-in area in a border area further next to the next border area, and
the boot program allows the information reproducing apparatus to access the border-out area in the first border area.

23. The information recording apparatus according to claim 22, wherein the boot program judges whether or not the information reproducing apparatus can recognize an information recording medium other than a read-only type information recording medium.

24. The information recording apparatus according to claim 22, wherein the boot program allows the information reproducing apparatus to recognize each of the plurality of border areas if it is judged that the information reproducing apparatus cannot recognize the information recording medium other than the read-only information recording medium.

25. The information recording apparatus according to claim 22, wherein said second recording device records the boot program in a position which is a predetermined address away from an edge portion of the first border area.

26. The information recording apparatus according to claim 22, wherein
said first recording device further records position information into each of the plurality of border areas as the record information, the position information indicating a position of a next border area, and
the boot program allows the information reproducing apparatus to access a recording area in which the position information is recorded.

27. The information recording apparatus according to claim 22, wherein
the information recording medium comprises a first recording layer and a second recording layer in which the record information is recorded,
said first recording device records the record information by the unit of the border area which is over the first recording layer and the second recording layer, and
said second recording device records the boot program into at least one of the first recording layer and the second recording layer.

28. The information recording apparatus according to claim 27, wherein said first recording device records the record information by the unit of the border area including a partial recording area of the first recording layer and a partial recording area of the second recording layer which faces to the partial recording area of the first recording layer.

29. The information recording apparatus according to claim 22, wherein said second recording device records the boot program onto the information recording medium by using a Boot Descriptor in a UDF (Universal Disk Format) file system.

30. An information recording method comprising:
a first recording process of recording record information onto an information recording medium in each border area, which is a unit in which the record information is recorded; and
a second recording process of recording a boot program into a first border area of a plurality of border areas which are formed by recording the record information, the boot program being executed by an information reproducing apparatus for reproducing the record information recorded on the information recording medium, the boot program allowing the information reproducing apparatus to recognize each of the plurality of border areas, wherein
each of the plurality of border areas includes a data area in which the record information is recorded, and a border-in area and a border-out area in each of which management information for managing the record information, which is recorded in the data area, is recorded as the record information,
said second recording process records the boot program in a position which is in the data area in the first border area and which is a predetermined address away from the border-out area in the first border area,
said first recording process further records position information into the border-out area in each of the plurality of border areas as the record information, the position information indicating a position of at least one of the border-out area in a border area next to the border area and the border-in area in a border area further next to the next border area, and
the boot program allows the information reproducing apparatus to access the border-out area in the first border area.

31. An information reproducing apparatus for reproducing the record information recorded by the information recording apparatus according to claim 22, said information reproducing apparatus comprising:
a reading device for reading the boot program;
an executing device for executing the read boot program;
a recognizing device for recognizing each of the plurality of border areas after the boot program is executed; and
a reproducing device for reproducing the record information recorded in each of the plurality of border areas recognized by said recognizing device.

32. The information reproducing apparatus according to claim 31, wherein
the boot program judges whether or not the information reproducing apparatus can recognize an information recording medium other than a read-only type information recording medium, and
the information reproducing apparatus recognizes each of the plurality of border areas if it is judged that the information reproducing apparatus cannot recognize the information recording medium other than the read-only information recording medium.

33. The information reproducing apparatus according to claim 31, wherein
the boot program is recorded in a position which is a predetermined address away from an edge portion of the first border area, and
said recognizing device accesses a position which is a predetermined address away from a recording area in which the boot program is recorded, to thereby recognize the first border area.

34. The information reproducing apparatus according to claim 31, wherein
each of the plurality of border areas includes a data area in which the record information is recorded, and a border-in area and a border-out area in each of which management information for managing the record information, which is recorded in the data area, is recorded as the record information,
the boot program is recorded in a position which is in the data area in the first border area and which is a predetermined address away from the border-out area in the first border area, and
said recognizing device accesses a position which is a predetermined address away from a recording area in which the boot program is recorded, to thereby recognize the border-out area in the first border area.

35. The information reproducing apparatus according to claim 31, wherein
position information is recorded in each of the plurality of border areas as the record information, the position information indicating a position of a next border area, and
said recognizing device refers to the position information, to thereby recognize each of the plurality of border areas.

36. The information reproducing apparatus according to claim 31, wherein
the information recording medium comprises a first recording layer and a second recording layer in which the record information is recorded, and
the record information is recorded by the unit of the border area which is over the first recording layer and the second recording layer.

37. An information reproducing method of reproducing the record information recorded by the information recording apparatus according to claim 22, said information reproducing method comprising:
a reading process of reading the boot program;
an executing process of executing the read boot program;
a recognizing process of recognizing each of the plurality of border areas after the boot program is executed; and
a reproducing process of reproducing the record information recorded in each of the plurality of border areas recognized by said recognizing process.

38. An information recording medium comprising a plurality of border areas in each of which the record information is recorded,
a first border area of the plurality of border areas further comprising a boot area in which a boot program is recorded, the boot program being executed by an information reproducing apparatus for reproducing the record information recorded on the information recording medium, the boot program allowing the information reproducing apparatus to recognize each of the plurality of border areas, wherein
each of the plurality of border areas includes a data area in which the record information is recorded, and a border-in area and a border-out area in each of which management information for managing the record information, which is recorded in the data area, is recorded as the record information,
said boot area is in the data area in the first border area and is a predetermined address away from the border-out area in the first border area,
position information is recorded into the border-out area in each of the plurality of border areas as the record information, the position information indicating a position of at least one of the border-out area in a border area next to the border area and the border-in area in a border area further next to the next border area, and
the boot program allows the information reproducing apparatus to access the border-out area in the first border area.

39. A computer program product in a computer-readable medium for tangibly embodying a program of instructions executable by a computer provided in the information recording apparatus according to claim 22, said computer program making the computer function as at least one portion of said first recording device and said second recording device.

40. A computer program product in a computer-readable medium for tangibly embodying a program of instructions executable by a computer provided in the information reproducing apparatus according to claim 31, said computer program making the computer function as at least one portion of said reading device, said executing device, said recognizing device, and said reproducing device.
